(19) United States
(12) Patent Application Publication
(10) Pub. No.: US 2008/0102225 A1
(43) Pub. Date: May 1, 2008

(54) Method for Manufacturing a Device Using Imprint Lithography and Direct Write Technology

(76) Inventors: Christopher P. Braun, City of Bath, PA (US); Sailesh Chittipeddi, City of Irvine, CA (US); Frederick R. Peiffer, City of Emmaus, PA (US)

Correspondence Address: HITT GAINES, PC;LSI Corporation, PO BOX 832570, RICHARDSON, TX, 75083, US

(21) Appl. No.: 11/817,827

(22) PCT Filed: Mar. 23, 2006
(86) PCT No.: PCT/US06/11005

§ 371 Date: Sep. 5, 2007

Related U.S. Application Data
(60) Provisional application No. 60/664,573, filed on Mar. 23, 2005.

(51) Int. Cl. B01J 19/08

(52) U.S. Cl. 427/596; 977/932

(57) ABSTRACT

The present invention provides a method for manufacturing a device, as well as a method for manufacturing an integrated circuit. The method for manufacturing the device, among others, may include forming one or more devices of a first type over a substrate using imprint lithography, and forming one or more devices of a second type over the substrate using a direct write technology.

### CROSS-REFERENCE TO RELATED APPLICATIONS

This application claims the benefit of PCT Serial No. PCT/US2006/011005 entitled “Selective Resolution Deposition for Nano-Circuits” to Sailish Chittipeddi, et al., filed on Mar. 23, 2006 which claims the benefit of U.S. Provisional Application No. 60/664,573 entitled “Selective Resolution Deposition for Nano-Circuits” to Sailish Chittipeddi, et al., filed on Mar. 23, 2005, which is commonly assigned with the present invention and incorporated herein by reference as if reproduced herein in its entirety.

### TECHNICAL FIELD OF THE INVENTION

The present invention is directed, in general, to a method for manufacturing a device and, more specifically, to a method for manufacturing a device using both an imprint lithography technology and direct write technology.

### BACKGROUND OF THE INVENTION

Optical lithography techniques are currently used to make most microelectronic devices. However, it is believed that these methods are reaching their limits in resolution. Sub-micron scale lithography has been a critical process in the microelectronics industry. The use of sub-micron scale lithography allows manufacturers to meet the increased demand for smaller and more densely packed electronic circuits on chips. It is expected that the microelectronics industry will pursue structures that are as small or smaller than about 50 nm. Further, there are emerging applications of nanometer scale lithography in the areas of opto-electronics and magnetic storage, among others. For example, photonic crystals and high-density patterned magnetic memory of the order of terabytes per square inch may require sub-100 nanometer scale lithography.

For making sub-50 nm structures, optical lithography techniques may require the use of very short wavelengths of light (e.g., about 13.2 nm). At these short wavelengths, many common materials are not optically transparent and therefore imaging systems typically have to be constructed using complicated reflective optics. Furthermore, obtaining a light source that has sufficient output intensity at these wavelengths is difficult. Such systems lead to extremely complicated equipment and processes that may be prohibitively expensive. It is also believed in the art that high-resolution e-beam lithography techniques, though very precise, are too slow for high-volume commercial applications, and thus should not be used.

Several imprint lithography techniques have been investigated as low cost, high volume manufacturing alternatives to conventional photolithography for high-resolution patterning. Imprint lithography techniques are similar in that they use a template containing topography (e.g., imprint mold) to replicate a surface relief in a film on the substrate. Unfortunately, these templates may be expensive to manufacture and tend to degrade with extended used.

Accordingly, what is needed in the art is a method for manufacturing devices using imprint lithography that does not experience the drawbacks discussed above.

### SUMMARY OF THE INVENTION

To address the above-discussed deficiencies of the prior art, the present invention provides a method for manufacturing a device, as well as a method for manufacturing an integrated circuit. The method for manufacturing the device, among others, may include forming one or more devices of a first type over a substrate using imprint lithography, and forming one or more devices of a second type over the substrate using a direct write technology.

In an alternative embodiment, the present invention provides the method for manufacturing the integrated circuit. The method for manufacturing the integrated circuit, without limitation, may include forming nano-scale devices over a substrate using imprint lithography, forming a dielectric layer over the nano-scale devices, and forming conductive features in, on or over the dielectric layer using a direct write technology, the conductive features contacting at least a portion of the nano-scale devices.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a flow diagram of a method of manufacturing a device in accordance with the principles of the present invention;

FIGS. 2-7 illustrate plan views showing how one might, in another embodiment, manufacture a device in accordance with the principles of the present invention; and

FIG. 8 illustrates a sectional view of an integrated circuit (IC) incorporating one or more active devices and conductive features constructed according to the principles of the present invention.

### DETAILED DESCRIPTION

The present invention is based, at least in part, on the acknowledgement that the current state of the art for imprint lithography requires very small area molds for imprinting, the small area molds being repeatedly employed to imprint larger devices. Based on this acknowledgement, the present invention further acknowledges that the overuse of the imprint molds while performing imprint lithography may cause the imprint molds to degrade over time, and thus need replacing. Because of the cost of the imprint molds themselves, and/or the refurbishment of the imprint molds, as well as the time required to manufacture such molds, there is currently a need to reduce the usage thereof.

Having made this acknowledgement, the present invention recognizes that the use of imprint lithography, and thus imprint molds, can be significantly reduced if the imprint lithography process is only used to manufacture those features specifically requiring the high-resolution patterning achievable using the imprint lithography process. Thus, imprint lithography could be used to manufacture those features needing high resolution, and a lesser resolution process could be used to manufacture those features needing less resolution. Accordingly, the present invention recognizes that the imprint lithography can be used to manufacture a first type of device (e.g., nano-scale devices) and that a direct writing technique can be used to manufacture a second type of device (e.g., micro-scale devices). Given the reduced usage of the imprint lithography process, the need for generating new molds and/or refurbishing the older molds is significantly reduced.

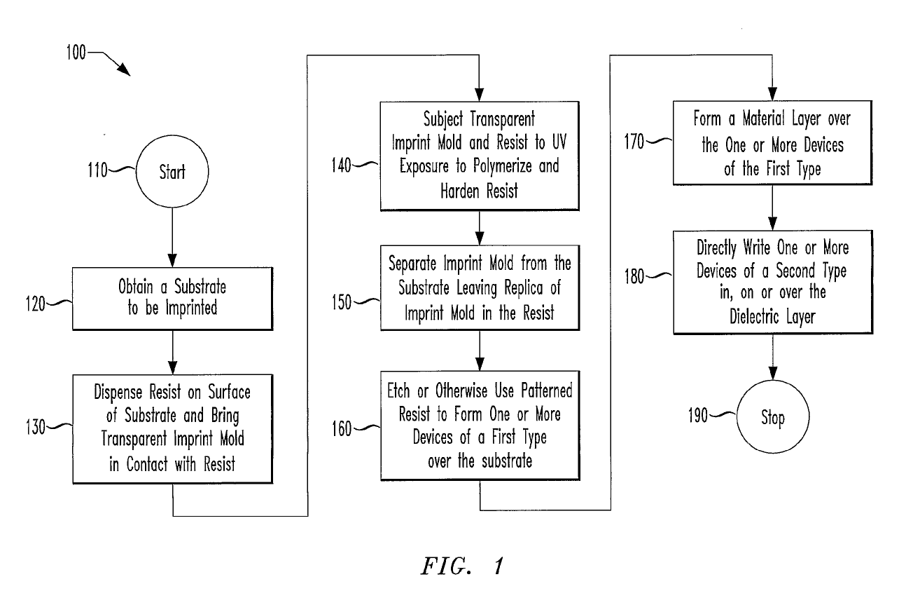

Turning to FIG. 1 illustrated is a flow diagram 100 of a method of manufacturing a device in accordance with the principles of the present invention. The flow diagram 100 of FIG. 1 begins with a start step 110. In a step 120, a substrate to be imprinted may be obtained. The substrate may be any layer located in a microelectronics, optoelectronics, nano technology, or other similar device, including a layer located at wafer level or a layer located above or below wafer level. For example, the substrate may be a semiconductor substrate, dielectric substrate, optical substrate, nano technology substrate, etc., including either rigid or flexible substrates, and remain within the purview of the present invention.

After obtaining the substrate in the step 120, one or more devices of a first type may be formed over the substrate using imprint lithography, for example using steps 130 thru 160. For instance, in a step 130 resist may be dispensed on a surface of the substrate. In one embodiment, the resist may be a low viscosity, silicon-containing monomer. However, those skilled in the art of imprint lithography understand the other types of materials that could be used for the resist.

Thereafter, a transparent imprint mold may be brought into contact with the resist. The transparent imprint mold, for example comprising a fused silica surface covered with a release layer, among others, may be gently pressed into the thin layer of resist. Accordingly, the resist should substantially, if not completely, fill the pattern created in the imprint mold.

Thereafter, in a step 140, the transparent imprint mold and the resist therein may be subjected to an ultraviolet (UV) light source. For instance, the transparent imprint mold and the resist may be exposed to a blanket UV light source, the UV light source polymerizing and hardening the resist. Those skilled in the art of imprint lithography, again, understand the conditions needed to polymerize and harden the resist.

After polymerizing the resist, the imprint mold may be separated from the substrate leaving a replica of the imprint mold in the resist, in a step 150. In an advantageous embodiment, the separation of the imprint mold from the substrate leaves an exact replica of the imprint mold. Thus, upon separation of the imprint mold from the substrate, a pattern (e.g., a circuit pattern) remains in the resist remaining on the substrate. The release layer briefly described above helps assist with the release of the imprint mold from the substrate. After removing the imprint mold from the substrate, a short etch, for example a short halogen etch, may be used to remove undisplaced, cured resist.

Thereafter, in a step 160, the resist remaining after removing the imprint mold may be used to etch, deposit, or otherwise form the one or more first type of devices over the substrate. For example, depending on the desires of the manufacturer, the remaining patterned resist may be used to form one or more active devices, and more particularly one or more nano-scale active devices over the substrate.

As those skilled in the art understand, imprint lithography (such as that discussed above) has several important advantages over conventional optical lithography and EUV lithography. The parameters in the classic photolithography resolution formula (k1, NA, and lambda) are not relevant to imprint lithography, because this technology does not use reduction lenses. Investigations into imprint lithography indicate that the resolution is only limited by the pattern resolution on the template, which is a direct function of the resolution of the template fabricating process.

After forming the one or more devices of the first type over the substrate in step 160, one or more devices of a second type may be formed over the substrate, for instance using steps 170 thru 180. In the flow diagram 100 of FIG. 1, step 170 consists of forming a material layer, for example a dielectric layer, over the one or more devices of the first type formed in step 160. The material layer, including the materials it may comprise, its thickness, and any other properties associated therewith or with its manufacture, may vary greatly while staying within the scope of the present invention. Accordingly, no further detail is warranted at this time.

Thereafter, in a step 180, one or more features of a second type may be directly written in, on or over the material layer. For example, any direct write technology could be used to form the one or more features of a second type (e.g., conductive features). Among others, a direct write technology using an electron beam or laser beam could be used to form the conductive features. Additionally, the direct write technology could use a raster or vector scan process during the writing process. Moreover, a multi-beam direct write process could be used. Likewise, a mask-less lithography technique including pattern transfer controlled by micro-electro-mechanical-system (MEMS) mirror devices reflecting illumination through a lens system to a target could also be used. Those skilled in the art of direct write technology understand the myriad of different processes that might be used to directly write the one or more features of a second type in, on or over the material layer. At this stage of manufacture, the process could return to a previous step, and thus repeat one or more of those steps, or alternatively stop at step 190.

The process for using imprint lithography to form the one or more devices of the first type described with respect to steps 130 thru 160 is but one embodiment of imprint lithography. Likewise, the direct write technology used to form the one or more devices of the second type described with respect to steps 170 thru 180 is but one embodiment of a direct write technology that might be used. Those skilled in the art understand the other imprint lithography processes and direct write processes that might be used to form the one or more devices of the first type and second type, respectively. Accordingly, the present invention should not be limited to any specific imprint lithography process or direct write process.

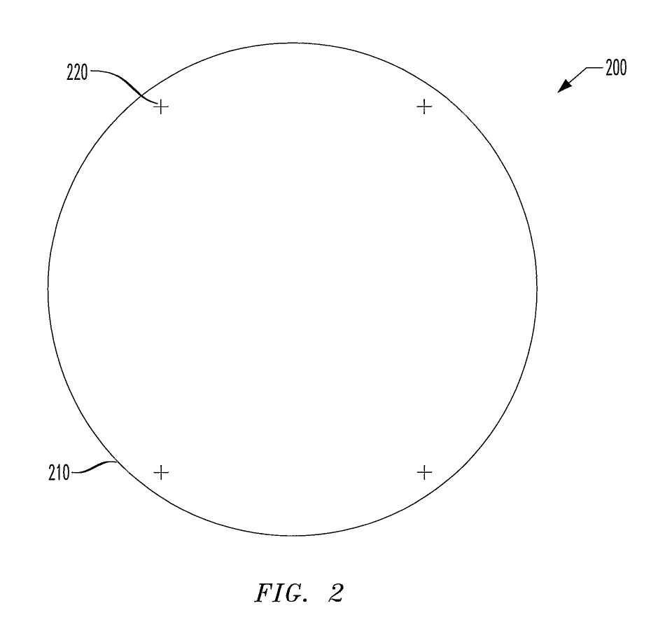

Turning now to FIGS. 2 thru 7, with brief references to FIG. 1, illustrated are plan views illustrating how one might, in another embodiment, manufacture a device 200 in accordance with the principles of the present invention. FIG. 2 illustrates a plan view of a substrate 210, such as a substrate that may have been obtained in the step 120. As indicated above, the substrate 210 may be any layer located in a microelectronics, optoelectronics, nano technology, or other similar device, including a layer located at wafer level or a layer located above or below wafer level, among others.

Optionally located at a known location on or in the substrate 210 may be alignment marks 220. The alignment marks 220, as shown in the embodiment of FIG. 2, are global alignment marks used to position subsequently formed features at precise locations over, on or in the substrate 210. In the embodiment shown, the substrate 210 includes three alignment marks. However, those skilled in the art of alignment understand that any number of global alignment marks could be used and remain within the scope of the present invention. In one embodiment, a full-field mask operation could be used to put down some initial layer or layers that would contain the alignment marks 220. However, other method could also be used for their manufacture.

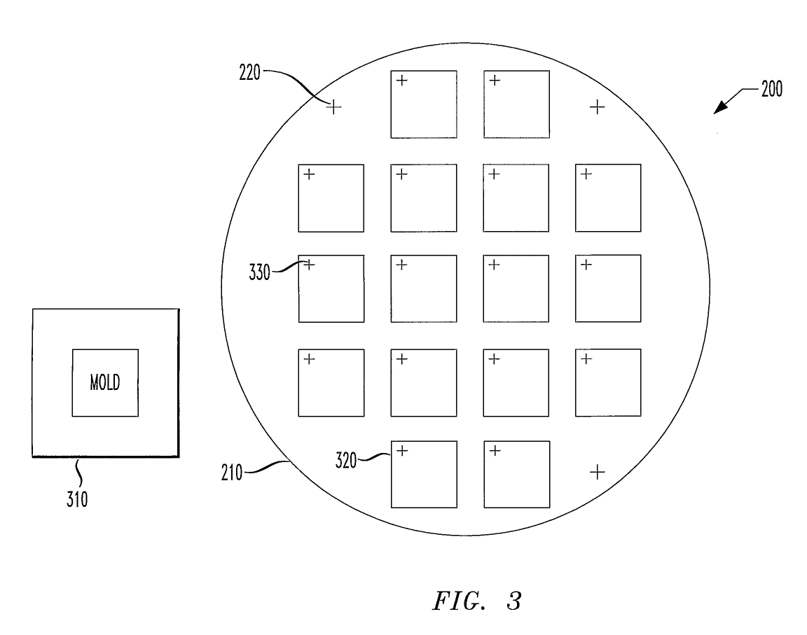

Turning now to FIG. 3, illustrated is the device 200 of FIG. 2 after forming one or more devices of the first type over the substrate 210. For instance, steps 130 thru 160 (discussed above) could be used to form the one or more devices over the substrate 210. As these steps were previously discussed, no further detail is warranted.

In the illustrative embodiment of FIG. 3, the process set forth in steps 130 thru 160 was repeated to provide multiple different regions 320 on the substrate 210, each of the multiple different regions 320 having the one or more first type of devices. For example, in FIG. 3, steps 130 thru 160 were repeated sixteen times, resulting in sixteen different regions 320. This step and repeat process is generally a function of the limitations of the mold 310 field size used to form the one or more devices of the first type. As one would expect, the alignment mark 220 may be used to position the different regions 320.

As also illustrated in FIG. 3, each of the different regions 320 would advantageously have a local alignment mark 330. As those skilled in the art appreciate, the local alignment marks 330 would allow subsequently formed features to be accurately positioned with respect to the different regions 320, and more particularly the one or more devices located therein. This is particularly advantageous for the step and repeat process described with respect to FIG. 3, as the positioning of different regions may vary greatly from the alignment mark 220.

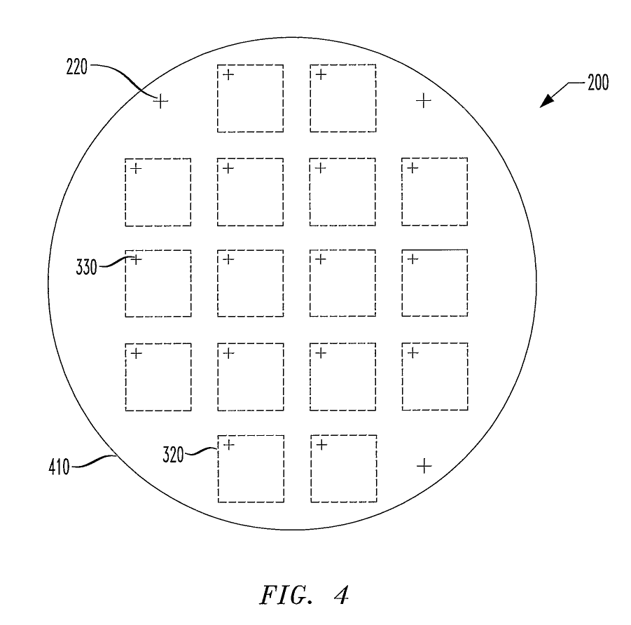

Turning now to FIG. 4, illustrated is the device 200 of FIG. 3 after forming a dielectric layer 410 over the substrate 210, and more particularly over the one or more devices of the first type. The dielectric layer 410 may be similar to the material layer formed in the step 170 discussed above. Accordingly, the dielectric layer 410, the materials it comprises, its thickness, and any other properties associated therewith or with its manufacture may vary greatly while staying within the scope of the present invention. In the embodiment shown, however, the dielectric layer 410 is an interlevel dielectric layer material.

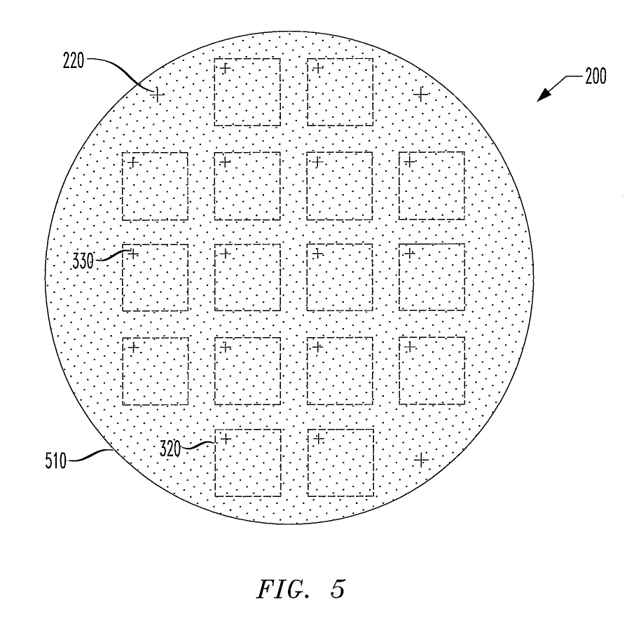

Turning now to FIG. 5, illustrated is the device 200 of FIG. 4 after forming a resist layer 510 over the dielectric layer 410. In the given embodiment, the resist layer 510 was blanket deposited over the dielectric layer 410. The resist layer 510 may be any resist layer known for use with direct write systems. Thus, those skilled in the art of direct writing would understand the details associated with the resist layer 510.

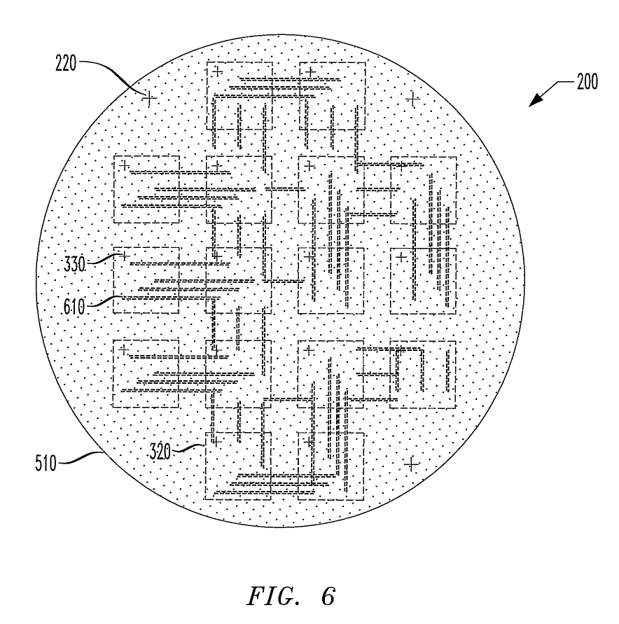

Turning now to FIG. 6, illustrated is the device 200 of FIG. 5 after subjecting the resist layer 510 to the direct write technology. For instance, in this embodiment, the resist layer 510 could be subjected to an electron beam configured to change the material properties of portions of the resist layer 510 subjected thereto. Thereafter, the blanket layer of resist 510 exposed to the direct write signal may be developed. In this embodiment, the development of the blanket layer of resist 510 leaves openings 610 in the resist 510. In this embodiment, the openings 610 in the resist would correspond to one or more devices of the second type, for instance one or more conductive features. It should be noted, however, that other direct write technologies could be used to form the openings 610. Therefore, the present invention is not limited to the direct write technology described with respect to FIG. 6.

Those skilled in the art understand that the direct write technology may, and more likely would, have the ability to detect the local alignment marks 330. Accordingly, the direct write technology should be able to make local alignment adjustments during writing, based upon those local alignment marks 330. As those skilled in the art appreciate, this is one significant benefits of this process, since the implant lithography step may introduce some local alignment issues, which could then be tuned out with the direct-write technology.

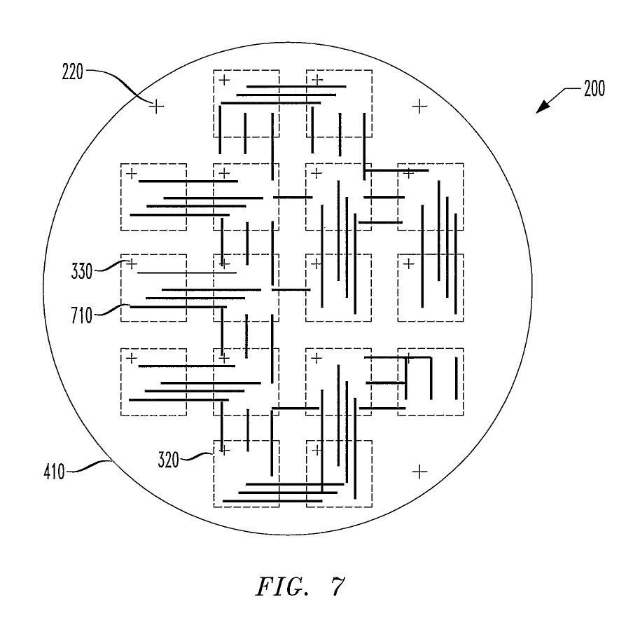

Turning now to FIG. 7, illustrated is the device 200 of FIG. 6 after forming a blanket layer of metallization over the patterned resist layer 510 and within the openings 610. The patterned resist layer 510 having the metallization thereon may then be removed, ultimately resulting in conductive features 710. As previously indicated, the conductive features 710 correspond to the openings 610 formed in the resist layer 510 using the direct write technology. The conductive features 710, as those skilled in the art appreciate, may be traces, interconnects or a combination of traces and interconnects and remain within the scope of the present invention. The process described with respect to FIGS. 5 thru 7 is somewhat similar to the process described above with respect to step 180.

In an alternative embodiment of the present invention, the conductive features 710 may be formed using a pyrolytic process. For example, in one embodiment an organic dye which absorbs selective laser light wavelengths, can be added to a metallo-organic solution prior to laser exposure, so as to enhance absorption of the laser light at the regions of the metallo-organic film that is subsequently exposed to the laser light. The increased light absorbance at the exposed regions, results in at least partial pyrolysis of the exposed metal. Regions of the metallo-organic film not exposed to laser pyrolysis are developed away using a solvent wash. Subsequent complete pyrolysis of the metal and rapid thermal annealing can produce conducting interconnect lines. More detailed information regarding pyrolysis may be found in U.S. Pat. Nos. 4,916,115, 4,952,556, and 5,164,565, all of which are incorporated herein by reference as if reproduced herein in their entirety.

The process discussed with respect to the flow diagram 100 of FIG. 1, or alternatively the process described with respect to FIGS. 2 thru 7, experiences many benefits over conventional processes. First, the process gets the full benefit of the imprint lithography for those features that require the high-resolution possible with imprint lithography, while not experiencing the problems associated with the extended use of the imprint molds of the imprint lithography process. Second, the process enables the interconnection of the high-resolution features in a cost effective manner using the direct write technology.

The process of the present invention would also experience a quicker overall production interval, since there would be no requirement to procure photo-masks for traditional optical lithography steps. The interval improvement would be most profound when applied to the initial prototyping of new products, thus improving the new product introduction interval. Moreover, cost saving would be achieved in the case of niche, application specific devices in which the overall number of devices would be small. In this case, the cost of the photo masks for the metallization levels would be avoided.

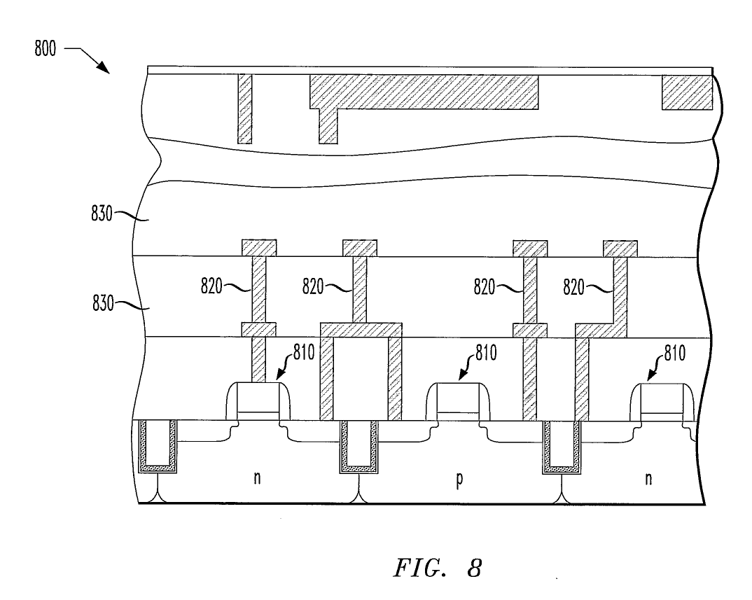

Turning lastly to FIG. 8, illustrated is a sectional view of an integrated circuit (IC) 800 incorporating one or more active devices 810 and conductive features 820 constructed according to the principles of the present invention. The IC 800 may include devices, such as transistors used to form CMOS devices, BICMOS devices, Bipolar devices, as well as capacitors or other types of devices. The IC 800 may further include passive devices, such as inductors or resistors, or it may also include optical devices, optoelectronic devices or nano technology devices. Those skilled in the art are familiar with these various types of devices and their manufacture, and particularly that these devices may, and will often, comprise nano-scale devices. In the particular embodiment illustrated in FIG. 8, the conductive features 820 are located within dielectric layers 830. The conductive features 820 contact the active devices 810, thus, forming the operational integrated circuit 800.

Although the present invention has been described in detail, those skilled in the art should understand that they could make various changes, substitutions and alterations herein without departing from the spirit and scope of the invention in its broadest form.

What is claimed is:

1. A method for manufacturing a device, comprising:
forming one or more devices of a first type over a substrate using imprint lithography; and
forming one or more devices of a second type over the substrate using direct write technology.

2. The method as recited in claim 1 wherein the one or more devices of a first type are one or more active devices and wherein the one or more devices of a second type are one or more conductive features for contacting the one or more active devices.

3. The method as recited in claim 2 wherein the one or more conductive features are any one or a collection of vias or traces.

4. The method as recited in claim 2 wherein forming one or more active devices over the substrate using imprint lithography includes using an imprint mold to form multiple different regions, each different region including one or more active devices.

5. The method as recited in claim 4 wherein forming one or more conductive features over the substrate includes using alignment marks to form the one or more conductive features and thereby accurately contact the one or more active devices in the multiple regions.

6. The method as recited in claim 5 wherein using alignment marks includes using local alignment marks associated with each of the multiple regions.

7. The method as recited in claim 1 wherein the one or more devices of the first type are one or more nano-scale devices and wherein the one or more devices of the second type are one or more micro-scale devices.

8. The method as recited in claim 1 wherein forming one or more devices of the second type over the substrate using direct write technology includes forming the one or more devices of the second type using an electron beam direct write technology.

9. The method as recited in claim 1 wherein forming one or more devices of the second type over the substrate using direct write technology includes forming the one or more devices of the second type using a laser electron beam direct write technology.

10. The method as recited in claim 1 wherein the one or more devices of the first type are microelectronic devices, optoelectronic devices, nanotechnology devices, or any combination thereof.

11. A method for manufacturing an integrated circuit, comprising:
forming nano-scale devices over a substrate using imprint lithography;
forming a dielectric layer over the nano-scale devices; and
forming conductive features in, on or over the dielectric layer using a direct write technology, the conductive features contacting at least a portion of the nano-scale devices.

12. The method as recited in claim 11 wherein the nano-scale devices are active devices.

13. The method as recited in claim 11 wherein the conductive features are any one or a collection of vias or traces.

14. The method as recited in claim 12 wherein forming nano-scale devices over the substrate using imprint lithography includes using an imprint mold to form multiple different regions, each different region including nano-scale devices.

15. The method as recited in claim 14 wherein forming conductive features in, on or over the dielectric layer includes using alignment marks to form the conductive features and thereby accurately contact the nano-scale devices in the multiple regions.

16. The method as recited in claim 15 wherein using alignment marks includes using local alignment marks associated with each of the multiple regions.

17. The method as recited in claim 11 wherein the nano-scale devices are microelectronic devices, optoelectronic devices, nanotechnology devices, or any combination thereof.

18. The method as recited in claim 11 wherein forming conductive features in, on or over the dielectric layer using a direct write technology includes forming the conductive features using an electron beam direct write technology.

19. The method as recited in claim 18 wherein forming conductive features in, on or over the dielectric layer using a direct write technology includes forming the conductive features using a raster scan or a vector scan process.

20. The method as recited in claim 11 wherein forming conductive features in, on or over the dielectric layer using a direct write technology includes forming the conductive features using a laser beam direct write technology.
